(19) United States
(12) Patent Application Publication
(10) Pub. No.: US 2010/0095463 A1
(43) Pub. Date: Apr. 22, 2010

(54) MULTI-FUNCTIONAL PLIERS

(76) Inventor: Shyi-Dong YANG, Taichung City (TW)

Correspondence Address: LEONG C LEI, PMB # 1008, 1867 YGNACIO VALLEY ROAD, WALNUT CREEK, CA, 94598, US

(21) Appl. No.: 12/255,673

(22) Filed: Oct. 22, 2008

(51) Int. Cl. B25F 1/00

(52) U.S. Cl. 7/107

(57) ABSTRACT

A multi-functional pliers is provided herein, which contains a pair of body members pin-joined together. Each body member contains a head section, a neck section, a body section, and a handle, series connected in this order. On a side of a head section and along its teeth, a number of indented and colored rings are provided. On the other side of the head section, there are a number of indented colored dots. The colored rings and dots provide visual clues to a terminal or wire of the right diameter. The interfacing sides of the neck sections 14 are impacted to form concaves with laterally curved walls with diminishing curvature outward away from the joining pin. On the other hand, each wall has a number of vertical creases and the creases are shallower as they are positioned more distant from the pin.

### TECHNICAL FIELD OF THE INVENTION

The present invention generally relates to pliers, and more particularly to a wire-cutting, wire-stripping, and terminal-crimping pliers.

### DESCRIPTION OF THE PRIOR ART

FIG. 4 shows a conventional wire-cutting, wire-stripping, and terminal-crimping pliers having a pair of handles 26 and a pivot 21. To an end of each handle 26, there is a head section 20 and a neck section 24 connecting the head section 20 to the handle 26. The neck sections 24 of the two handles 26 are overlaid and riveted together by a pin 21. Each neck section 24 has a number of through holes 22 for crimping terminals. Cutting and stripping teeth are also provided along the interfacing edges of the head sections 20 and the handles 26. Colored dots 23 are provided on a side of a head section 20 along the teeth so that an operator could easily locate the right teeth for a terminal or wire of a specific diameter by matching the dot color to the sheath color of the terminal or wire. For conventional pliers, these colored dots 23 are created by impacting the head section 20 to form shallow indentations and then painting the indentations.

Due to the shallowness of the indentations, their colored paints are often stripped or worn off after the pliers is used for an period of time. In addition, the pliers is not held with this side up, the operator cannot see the colored dots 23 directly, adding inconvenience to the usage of the pliers.

Further more, in order to have the two handles 26 flatly stacked together, the interfacing sides of the neck sections 24 are impacted to form concaves with sharp walls 25. When the head sections 20 are applied to something very hard, the stress is concentrated on the walls 500, causing the teeth of the head sections to deviate from each other. The terminal or wire being working on therefore suffers uneven force, producing unsatisfactory result.

### SUMMARY OF THE INVENTION

A multi-functional pliers is provided herein, which contains a pair of body members pin-joined together. Each body member contains a head section, a neck section, a body section, and a handle, series connected in this order. On a side of a head section and along its teeth, a number of indented and colored rings are provided. On the other side of the head section, there are a number of indented colored dots. The colored rings and dots provide visual clues to a terminal or wire of the right diameter.

The interfacing sides of the neck sections 14 are impacted to form concaves with laterally curved walls with diminishing curvature outward away from the joining pin. On the other hand, each wall has a number of vertical creases and the creases are shallower as they are positioned more distant from the pin.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a pliers according to an embodiment of the present invention with its handles opened.

FIG. 2 is a perspective diagram showing the head and neck sections of the pliers of FIG. 1.

FIG. 3 is a perspective diagram showing the pliers of FIG. 1 at a reversed viewing angle from that of FIG. 1 with the pliers' handles closed.

FIG. 4 is a perspective diagram showing a conventional pliers.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

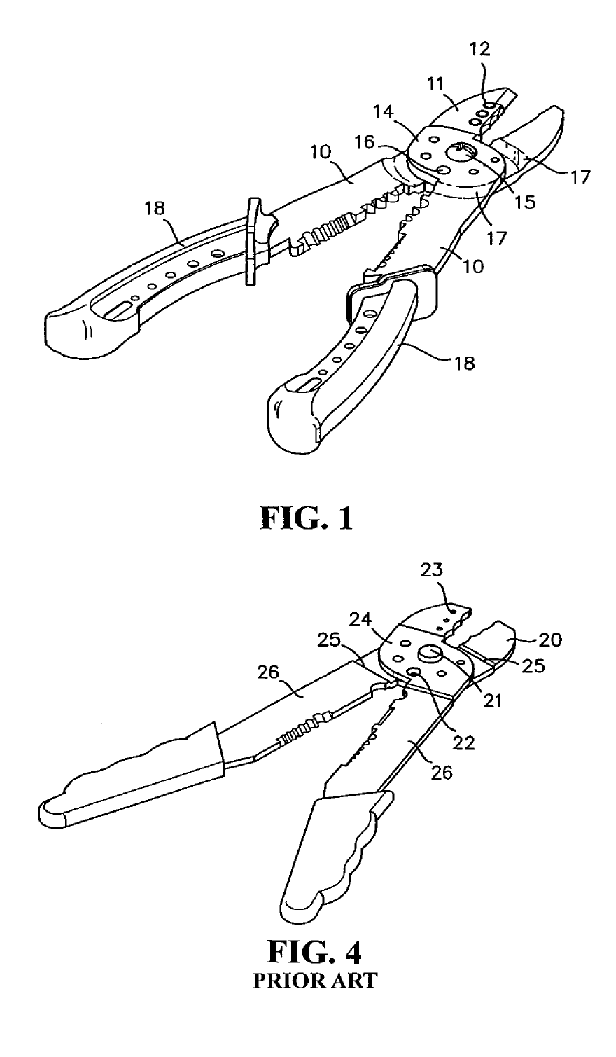

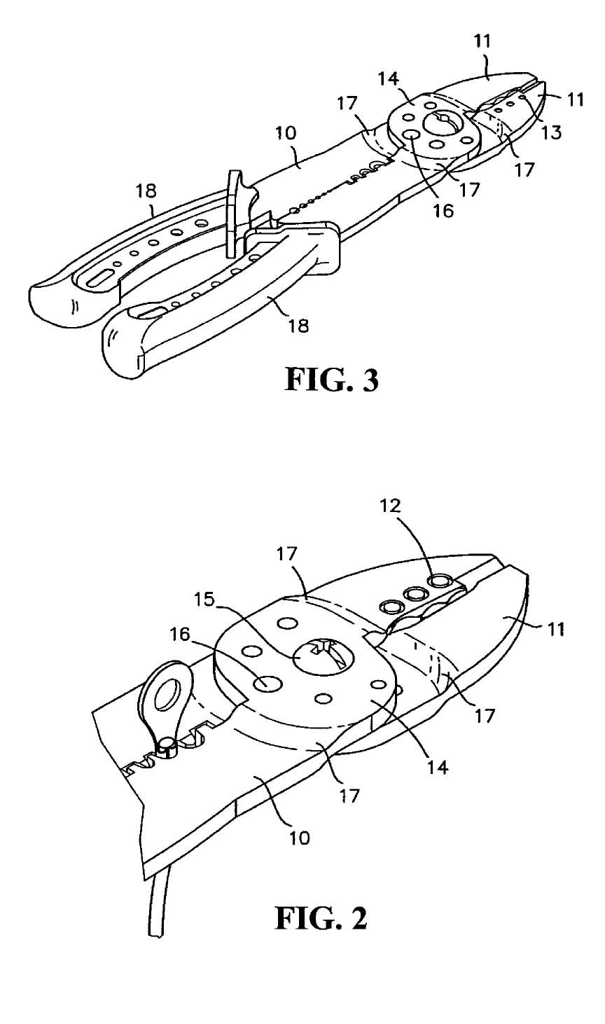

As shown in FIGS. 1 to 3, a multi-functional pliers according an embodiment of the present invention contains a pair of body members pin-joined together. Each body member contains a head section 11, a neck section 14, a body section 10, and a handle 18, series connected in this order.

Teeth are provided on the interfacing edges of the head sections 11. On a side of a head section 11 and along its teeth, a number of indented rings 12 are provided. Each indented ring 12 is painted with a specific color matching a corresponding sheath color of a terminal or wire of a specific diameter. On the other side of the head section 11, there are a number of indented dots 13 painted with the colors matching those of their corresponding rings 12 at the other side. As such, no matter the operator is right-handed or left-handed, the colored rings 12 or dots 13 provide visual clues to the terminal or wire of the right diameter.

The neck sections 14 are overlaid and riveted together by a pin 15. Each neck section 14 has a number of through holes 16 for crimping terminals. In order to have the two body members flatly stacked together, the interfacing sides of the neck sections 14 are impacted to form concaves with walls 17. Each wall 17 is laterally curved with diminishing curvature outward away from the pin 15, matching the curvature of the neck section 14 embedded in the concave and providing a natural constraint to the neck section 14. On the other hand, each wall 17 has a number of vertical creases and the creases are shallower as they are positioned more distant from the pin 15. These creases enhance the strength of the head sections 11 and also help preventing the stress from being concentrated on the walls 17.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A multi-functional pliers having a pair of pin-joined body members, each body member comprising a head section, a neck section, a body section, and a handle, series connected in this order; wherein
teeth are provided on interfacing edges of said head sections; on a side of a head section and along its teeth, there are a plurality of indented rings; on the other side of said head section, there are a plurality of indented dots, matching in location with said indented rings, respectively; said indented rings and dots are painted with different colors matching the sheath colors of terminals or wires of appropriate diameters;
said neck sections are riveted together by a pin; each neck section has a plurality of through holes for crimping terminals; the interfacing sides of said neck sections are impacted to form concaves with laterally curved walls; and each wall has a plurality of vertical creases.

2. The pliers according to claim 1, wherein said creases are shallower as they are positioned more distant from said pin.

3. The pliers according to claim 1, wherein said walls have a diminishing curvature as they extends outward away from said pin, matching the curvature of said neck sections embedded in said concaves.
